(19) United States
(12) Patent Application Publication
(10) Pub. No.: US 2012/0323637 A1
(43) Pub. Date: Dec. 20, 2012

(54) OPTIMIZATION OF ATTRIBUTES IN A PORTFOLIO OF COMMERCIAL AND INDUSTRIAL FACILITIES

(76) Inventors: Vincent J. Cushing, Chicago, IL (US); Gregor P. Henze, Boulder, CO (US)

(21) Appl. No.: 13/405,153

(22) Filed: Feb. 24, 2012

Related U.S. Application Data
(60) Provisional application No. 61/446,243, filed on Feb. 24, 2011.
(60) Provisional application No. 61/514,477, filed on Aug. 3, 2011.
(60) Provisional application No. 61/446,233, filed on Feb. 24, 2011.

(51) Int. Cl. G06Q 10/06

(52) U.S. Cl. 705/7.36

(57) ABSTRACT

Deployment of commercial and industrial (“C&I”) facilities in wholesale markets may be optimized by unbundling attributes from the facilities and combining those attributes for deployment. Buildings within portfolios may include complimentary attributes, features, and capabilities that can be coordinated for synergistic effect. The optimization may include mathematically unbundling attributes of each facility that may be mathematically and optimally aggregated into synthetic resources that are matched for selecting particular markets. These synthetic resources may be deployed optimally in the selected markets.

### PRIORITY CLAIM

This application claims priority to U.S. Prov. App. No. 61/446,243, entitled “USE OF DECISION ANALYSIS TO MAXIMIZE OPERATING MARGIN WHEN DEPLOYING AN AGGREGATION & INDUSTRIAL FACILITIES IN A WIDE ARRAY OF ELECTRIC AND GAS MARKETS”, filed on Feb. 24, 2011; and U.S. Prov. App. No. 61/446,233, entitled “INTEGRATION OF COMMERCIAL BUILDING OPERATIONS WITH ELECTRIC SYSTEM OPERATIONS AND MARKETS”, filed on Feb. 24, 2011; each of which are incorporated by reference. This application is related to U.S. application Ser. No. 13/404,748, entitled “INTEGRATION OF COMMERCIAL BUILDING OPERATIONS WITH ELECTRIC SYSTEM OPERATIONS AND MARKETS”, filed on Feb. 24, 2012, the entire disclosure of which is incorporated by reference.

### BACKGROUND

Efforts to reduce energy consumption traditionally focus on reducing energy costs at the customer meter. The building of a facility may be optimized for energy efficiency upon creation, but large scale demand elasticity and cost savings for multiple buildings is only treated with each building as a single unit in terms of demand control.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of a system illustrating facilities interacting with markets.

FIG. 2 is a diagram of a system illustrating aggregation.

FIG. 3 is a diagram of a system that generates a synthetic resource.

FIG. 4 is a diagram illustrating the process the system uses to generate synthetic resources.

FIG. 5 is a diagram illustrating an exemplary unbundler.

FIG. 6 is a diagram illustrating an exemplary aggregator.

FIG. 7 is a diagram illustrating exemplary attributes.

FIG. 8 is a diagram illustrating exemplary markets.

FIG. 9 is a diagram illustrating synthetic resource deployment and communications.

FIG. 10 is a flowchart illustrating optimization.

FIG. 11 is a diagram of a system illustrating an optimal use of flexible, high performing buildings as part of an aggregation.

FIGS. 12a, 12b, and 12c are graphical representations of building attributes.

FIG. 13 is a diagram of staged decision analysis.

FIG. 14 is a diagram illustrating critical mass.

FIGS. 15a-b are graphical representations of financial risk management profiles.

FIG. 16 is a diagram illustrating facility aggregation.

FIG. 17 is a diagram illustrating a thermal network model.

### DETAILED DESCRIPTION

By way of introduction, deployment of commercial and industrial (“C&I”) facilities in wholesale markets may be optimized by unbundling dynamic attributes of the facilities and rebundling those attributes for in a manner that is commercially valued when deployed in electric grid markets and operations. Decision analysis techniques may be used for the unbundling and rebundling of such attributes to optimize such commercial value. The optimization may create large scale demand elasticity leading to advantages for C&I facility operators, consumers, energy generation operators, and the environment. In particular, buildings within portfolios may include complimentary attributes, features, and capabilities that can be coordinated for synergistic effect. The optimization described below may include mathematically unbundling attributes of each facility. The unbundled parts from multiple facilities may be mathematically and optimally combined or rebundled into synthetic resources that are matched to the needs of selected gas and/or electric markets. Copending U.S. application Ser. No. 13/404,748, entitled “INTEGRATION OF COMMERCIAL BUILDING OPERATIONS WITH ELECTRIC SYSTEM OPERATIONS AND MARKETS”, filed on Feb. 24, 2012, the entire disclosure of which is incorporated by reference, describes an improved methodology and system for managing buildings to achieve a reduction in energy costs, including dispatching resources relative to grid markets and opportunities. As described below, those techniques may be applied to a portfolio of buildings.

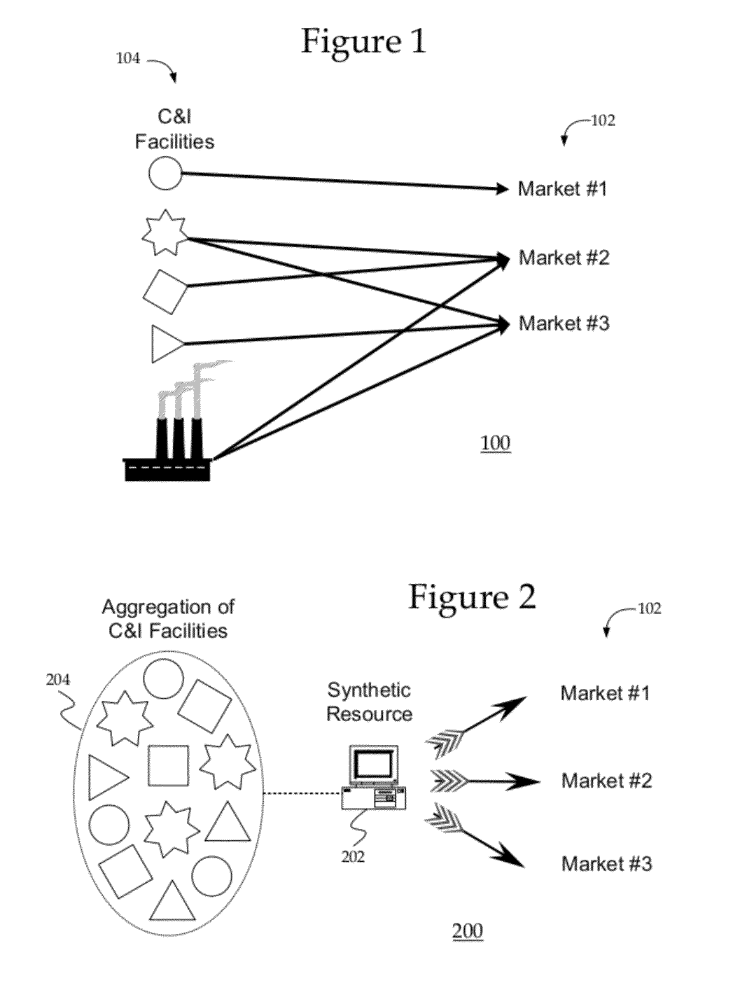

FIG. 1 is a diagram of a system 100 illustrating facilities interacting with markets. Commercial and industrial (“C&I”) facilities 104 may access a plurality of markets 102. Markets 102 may include energy, capacity, spinning reserve, regulation, balancing, frequency control, and other electric grid functions and are further described with respect to FIG. 8. The markets 102 may be wholesale power markets including energy, capacity, and ancillary services. Within each of those there may be several products and services.

The wholesale power market is one example of a market 102 and may refer to the purchase and sale of electricity from generators to resellers (who sell to retail customers), along with the ancillary services needed to maintain reliability and power quality at the transmission level.

A day-ahead market may be a forward market for energy and ancillary services to be supplied during the settlement period of a particular trading day that is conducted by the Independent System Operator, the power exchange, and other Scheduling Coordinators. This market may close with the Independent System Operator's acceptance of the final day-ahead schedule.

A capacity market refers to an amount of electric power delivered or required by a generator, turbine, transformer, transmission circuit, station, or system. The power provided may be firm power (e.g. power or power-producing capacity intended to be available at all times during the period covered by a guaranteed commitment to deliver, even under adverse conditions) or non-firm power (e.g. power or power-producing capacity supplied or available under a commitment having limited or no assured availability).

The ancillary services market may refer to necessary services that are provided in the generation and delivery of electricity and may include: coordination and scheduling services (load following, energy imbalance service, control of transmission congestion); automatic generation control (load frequency control and the economic dispatch of plants); contractual agreements (loss compensation service); and support of system integrity and security (reactive power, or spinning and operating reserves).

The commercial sector may generally be defined as nonmanufacturing business establishments, including hotels, motels, restaurants, wholesale businesses, retail stores, and health, social, and educational institutions. The utility may classify commercial service as consumers whose demand or annual use exceeds some specified limit. The limit may be set by the utility based on the rate schedule of the utility.

The industrial sector may generally defined as manufacturing, construction, mining agriculture, fishing and forestry establishments. The utility may classify industrial service based on demand or annual usage exceeding some specified limit. The limit may be set by the utility based on the rate schedule of the utility.

The planning, implementation, and monitoring of utility activities may be designed to encourage consumers to modify patterns of electricity usage, including the timing and level of electricity demand and may refer to energy and load-shape modifying activities that are undertaken in response to utility-administered programs.

C&I facilities 104 may have direct access to multiple markets 102 as shown in FIG. 1. C&I facilities 104 were traditionally employed in these markets 102 similar to generating plants. In other words, each facility 104 participates independently in one or more markets 102. Each facility 104 participates “as is”, that is, participates as best it can recognizing that it is a bundle both of operating capabilities and limitations that may be better suited for certain markets. As designed and operated, C&I facilities 104 are meant for an entirely different purpose. That is, C&I facilities do not look or operate like generating plants. So, C&I facilities “as is” may be even less suited to energy markets. For example, an industrial facility may be better suited for capacity markets that require curtailment of load for extended hours—the facility might shut down one of its production lines. It may have difficulty changing its production line for an hour or a minute as required by energy and ancillary service markets. As another example, a commercial building may be better suited for energy and ancillary service markets that require moving loads up and down for short periods of time—the building might take advantage of thermal inertia and so vary chiller operation minute to minute or hour to hour without tenant discomfort. It may have difficulty shutting down operation for extended hours as required by capacity markets.

C&I facilities 104 may include industrial plants as well as commercial buildings. For example, industrial plants may include a cement factory, a steel factory, auto manufacturer, or factory that assembles machines. Generally, any facility including multiple energy consumptive attributes that may be unbundled and rebundled could be a C&I facility 104. Custom deployment strategies may depend on the industrial process of the facility 104 and its technology, automation, flexibility, and/or economics.

C&I facilities 104 may include any commercial buildings with multiple energy consumptive attributes that could be unbundled and rebundled. For example, large buildings with central cooling and heating, automated control, and variable frequency drives may be examples of C&I facilities 104. Deployment strategies may depend on the heating, ventilation, and air conditioning (“HVAC”) technology, as well as local climate, season, fuel, automation, and/or building construction.

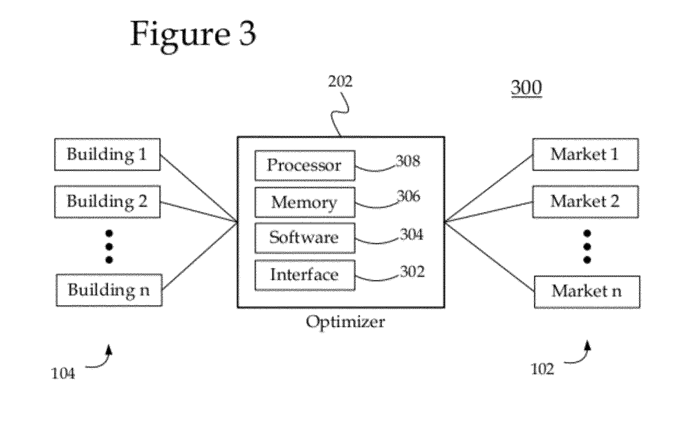

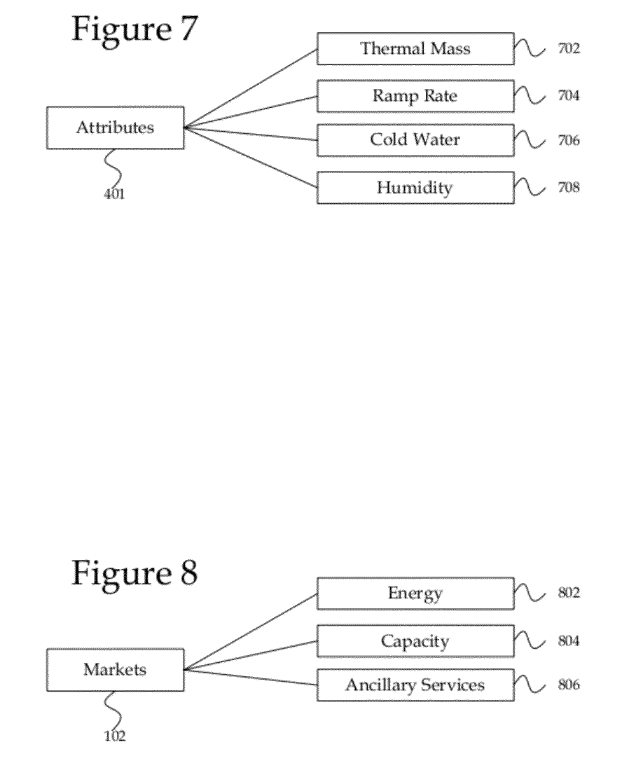

FIG. 2 is a diagram of a system 200 illustrating aggregation. The system 200 illustrates an optimizer 202 that organizes an aggregation 204 of facilities for access to the markets 102. In FIG. 1, each building participates in one or more markets as a separate entity, while in FIG. 2 the system's 200 various attributes from each facility may be unbundled and rebundled into synthetic resources for deployment as an aggregation 204 or portfolio of facility parts. Attributes are further described below with respect to FIG. 7. The unbundled parts from multiple facilities may be mathematically and optimally rebundled into synthetic resources that match selected markets for optimal deployment to those markets. The unbundling and rebundling may be performed by an optimizer 202. The optimizer 202 may result in the centralized control and deployment of resources/supply, such as synthetic resources, for multiple facilities from markets. The optimizer 202 is further described below with respect to FIGS. 3-6.

Electric generating plants may provide/sell capacity, energy, and ancillary services to the electric grid. Facilities/buildings may not look like or perform like a generating plant. The selected attributes are combined across several buildings so that the same functional service can be provided to the ancillary market as a generating plant. This is treated like an operations research or decision analysis problem. At any given time, there may be choice of as to how best to combine these buckets of attributes so as maximize value across a choice of several markets.

The synthetic resource may be the outcome or product of optimization. It may be synthetic because it performs one or more of the functions of a generating plant. It may be the product/service that buildings/facilities provide to the market, such as if generation is temporarily less than electric load on the system then the two are brought into balance by temporarily increasing generation or temporarily reducing electric load.

The combination or aggregation 204 of multiple facilities may be referred to as a portfolio. The portfolio of facilities may improve energy usage and solve supply problems that may have plagued a single facility, but that may be tempered by utilizing a portfolio of facilities. The scale and/or portfolio concepts that may be applied to retail participation in markets (such as wholesale energy) to include (1) achieving scale for markets that require minimum participation volume, and (2) achieving reliability and predictability of performance that comes from a diversity of facilities, or that come from the absence of common mode failure.

FIG. 3 is a diagram of a system 300 illustrating an optimizer 202. As shown in FIG. 3, facilities 1-n 104 may be coupled with the optimizer 202, as well as markets 1-n 102. There may be any number of facilities 104 and any number of markets 102. The optimizer 202 may aggregate attributes from a number of commercial and industrial facilities. In particular, the optimizer 202 may unbundle and rebundle/aggregate attributes from the facilities 104 to optimize deployment with the markets 102. The optimizer 202 may be a computing device for the unbundling, aggregating, analyzing, and deploying. The optimizer 202 may include a processor 308, memory 306, software 304 and an interface 302.

The interface 302 may communicate with any of the commercial and industrial facilities, as well as the markets. The interface 302 may include a user interface configured to allow a user and/or administrator to interact with any of the components of the optimizer 202. For example, the administrator and/or user may be able to configure the settings and features (e.g. decision analysis techniques and parameters) of the optimizer 202.

The processor 308 in the optimizer 202 may include a central processing unit (CPU), a graphics processing unit (GPU), a digital signal processor (DSP) or other type of processing device. The processor 308 may be a component in any one of a variety of systems. For example, the processor 308 may be part of a standard personal computer or a workstation. The processor 308 may be one or more general processors, digital signal processors, application specific integrated circuits, field programmable gate arrays, servers, networks, digital circuits, analog circuits, combinations thereof, or other now known or later developed devices for analyzing and processing data. The processor 308 may operate in conjunction with a software program, such as code generated manually (i.e., programmed).

The processor 308 may be coupled with a memory 306, or the memory 306 may be a separate component. The interface 302 and/or the software 304 may be stored in the memory 306. The memory 306 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 306 may include a random access memory for the processor 308. Alternatively, the memory 306 may be separate from the processor 308, such as a cache memory of a processor, the system memory, or other memory. The memory 306 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 306 is operable to store instructions executable by the processor 308.

The functions, acts or tasks illustrated in the figures or described herein may be performed by the programmed processor executing the instructions stored in the memory 306. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 308 is configured to execute the software 304. The software 304 may include instructions that perform decision analysis for unbundling and aggregating attributes for optimizing resources from markets.

The interface 302 may be a user input device or a display. The interface 302 may include a keyboard, keypad or a cursor control device, such as a mouse, or a joystick, touch screen display, remote control or any other device operative to interact with the optimizer 202. The interface 302 may include a display coupled with the processor 308 and configured to display an output from the processor 308. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 308, or as an interface with the software 304 for providing input parameters. In particular, the interface 302 may allow a user to interact with the optimizer 202 to view or modify the decision analysis parameters for aggregating commercial and industrial facilities.

The present disclosure contemplates a computer-readable medium that includes instructions or receives and executes instructions responsive to a propagated signal, so that a device connected to a network can communicate voice, video, audio, images or any other data over a network. The interface 302 may be used to provide the instructions over the network via a communication port. The communication port may be created in software or may be a physical connection in hardware. The communication port may be configured to connect with a network, external media, display, or any other components in the systems of FIGS. 1-3, or combinations thereof. The connection with the network may be a physical connection, such as a wired Ethernet connection or may be established wirelessly as discussed below. Likewise, the connections with other components may be physical connections or may be established wirelessly. Any of the components in the system 100 may be coupled with one another through a network. For example, the optimizer 202 may be coupled with any of the commercial or industrial facilities or any of the markets through a network. Accordingly, any of the components in the system 100 may include communication ports configured to connect with a network.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

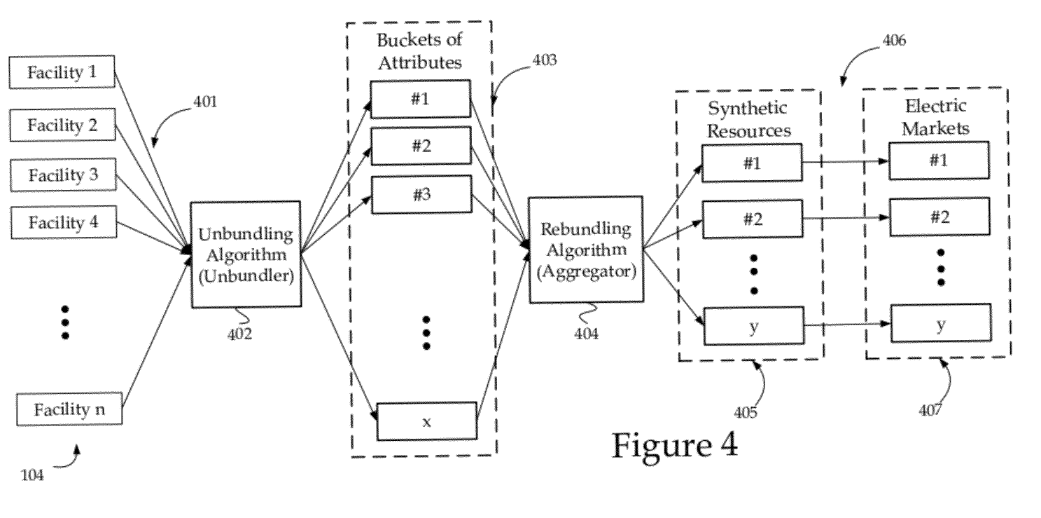

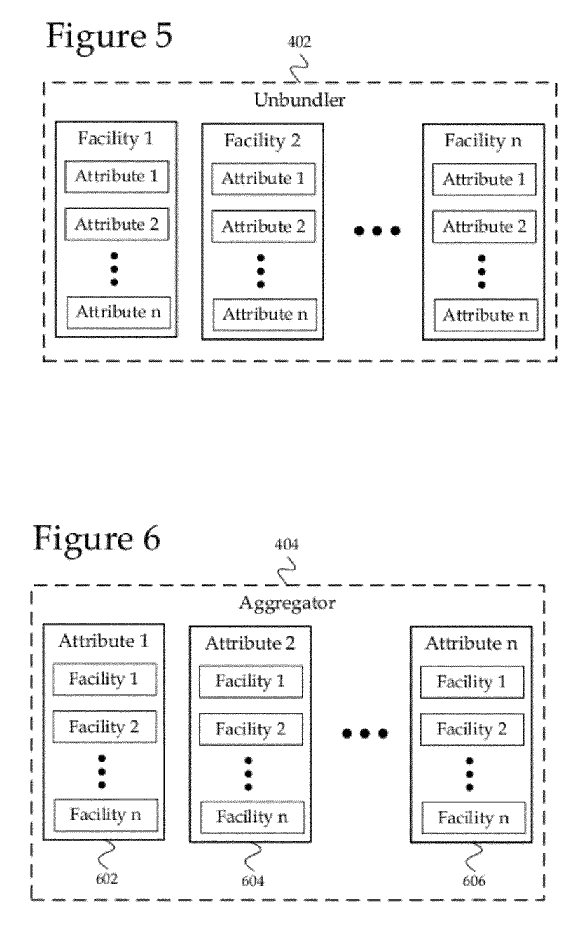

FIG. 4 is a diagram illustrating components of an optimizer 202. The optimizer 202 may include an unbundler 402, an aggregator 404, and deployment 406 (which may be through a deployer—not shown). The unbundler 402 may also be referred to as a divider and includes an unbundling algorithm. The unbundler 402 is further described with respect to FIG. 5. The unbundler 402 may receive attributes 401 from the facilities 104 that are unbundled as shown in the bucket of attributes 403. The attributes 401 are further described with respect to FIG. 7. The unbundler 402 identifies attributes from each of the facilities 104 and separates them for optimization into the bucket of attributes 403. The aggregator 404 may utilize a rebundling algorithm for combining or rebundling those attributes in an optimal manner. The rebundled attributes may be in the form of synthetic resources 405. The deployer 406 matches the synthetic resources 405 with the electric markets 407. The matching results in an optimal deployment 406 of resources. This deployment 406 may be through a deployer (not shown). Deployment strategies may include the manner in which a C&I facility participates in and derives profit from markets, possibly across several time dimensions (real time, daily, weekly, monthly, annual, or longer-term). In particular, hundreds of buildings are unbundled into fewer common attributes, which are then rebundled into even fewer synthetic resources that have a one-to one relationship with an equal number of markets for which the synthetic resources were custom created.

Any of the unbundler 402, aggregator 404, and/or deployer may be combined. In particular, the rebundling options may depend on how the resources are unbundled, and deployment options may depend on how the resources are rebundled. The unbundler 402, aggregator 404, and/or deployer may repeat its process over several time periods—annually, monthly, weekly, daily, real-time, or at other time intervals. In one embodiment, the unbundling and rebundling may be updated monthly while deployment strategy is updated hourly. Alternatively, the unbundling may be updated monthly, the rebundling may be updated weekly, and the deployment may be updated every five minutes. A constraint on updating periods is that, since each of the periods or components may depend on the results of another period or component, there may be no benefit in repeating the unbundling more frequently than the rebundling, and no benefit in repeating the rebundling any more frequently than the deployment.

Any of the unbundler 402, aggregator 404, and/or deployer may include decision analysis techniques for optimizing the supply of resources from the markets to the facilities. Decision analysis techniques involve a simulation of unbundling, rebundling and/or deployment strategies and comparison of the predicted results of any or all of those strategies to determine an optimal unbundling, rebundling or deployment. Decision analysis techniques may include a wide range of analytical methods, including, for example, real options, general option theory, mean-variance portfolio theory, linear programming, Monte Carlo simulation, sensitivity analysis, regression analysis, linear and non-linear optimization models, time series forecasting, arbitrage pricing theory, decision trees, and techniques for quantitatively analyzing decisions under uncertainty, including the use of distributions to model uncertainty.

In one example, thermal mass is an attribute in a particular building. The thermal mass may be changed by: 1) bleeding the battery at a fast ramp rate/response for a short duration (participating in spinning reserve market); 2) bleeding the battery at a slow ramp rate/response for a longer duration (participating in 5 or 60 min balancing or real-time energy market); 3) not bleeding the battery, but instead cycling the battery up/down, second-to-second (participation in regulation market); 4) holding the battery in reserve and thus preserving the opportunity to bleed the battery in the event of a very high price spike(s) likely to occur on a very hot afternoon in a grid-congested city; or 5) holding the battery in reserve in case one of the other buildings has a random equipment failure that precludes fulfilling its own battery commitment. The proper choice may depend on several decision variables, for example: 1) the relative values of each of those market opportunities at any time; 2) whether there's enough of the same attribute in aggregate buildings to meet some minimum size or performance necessary for participation in any/each of the markets; 3) whether the value of some optimal deployment of the synthetic resource covers the preceding night's cost of charging the “battery”. Linear programming may be used to find the optimum solution. If the cost of charging and the value of each opportunity is represented as a distribution, then Monte Carlo simulation or option analyses may be combined with linear programming.

Decision analysis techniques may identify facility deployment strategies that maximize benefit for a single C&I facility participating in emerging markets. This may or may not be a natural extension of the current manner in which C&I facilities are currently deployed in gas and electric markets. The current manner may use decision analysis to decide which one of several market opportunities a whole (“as is”) building should be dispatched in at any period in time. In many cases, a single building lacks the capability and may not participate in most market as a stand-alone. In one example, in the past, for four hour participation in a capacity market, buildings may have dimmed hallway lights, shut down elevator banks, and raised the thermostat. By contrast, decision analysis techniques may create synthetic C&I resources and identify optimal resource deployment strategies that maximize benefit for an aggregation of C&I facilities. Such optimal deployment strategies may identify a benefit that exceeds the sum of the benefits identified by optimal deployment strategies for individual facilities. This approach may put increasing value on larger and larger aggregation of C&I facilities, where there are increasingly broader (and potentially more profitable) choices as to how to participate in several markets to achieve greatest benefit. The benefit sought by the decision analysis techniques may include increased revenues or net income; decreased expense; improved risk profile where risk profile may address, for example, risk of large loss, risk of poor returns, credit risk, or risk of volatile returns.

FIG. 5 is a diagram illustrating an exemplary unbundler 402. The unbundler 402 unbundles attributes 401 from multiple facilities 104. As shown in FIG. 5, there may be n facilities; where n is any positive integer. Each of the facilities may have n attributes, where n is any positive integer. Each facility may have different attributes and a different number of attributes. For example, facility 1 may have attributes 1 and 3, while facility 2 has attributes 2 and 3. The unbundler identifies the individual attributes for each of the facilities. The identified attributes from each facility may be passed to the aggregator 404.

FIG. 6 is a diagram illustrating an exemplary aggregator 404. The aggregator 404 rebundles the attributes into optimal groupings for deployment with the markets. For example, FIG. 2 illustrates a single aggregation 204 of attributes. FIG. 6 illustrates n attributes that are aggregated individually as 602, 604, and 606. Although not shown, different facilities may have different attributes. For example, attribute 1 may be present in facilities 1 and 3, while attribute 2 may be present in facilities 2 and 3. The aggregation of individual attributes from different facilities may optimize deployment between facilities and markets.

FIG. 7 is a diagram illustrating exemplary attributes 401. Attributes 401 may include facility features or capabilities that may affect energy usage over time periods of seconds to weeks. For example, the thermal mass 702 affects when a facility requires energy for heating or cooling and may be controlled by a thermostat. The thermal mass is an attribute with character paralleling that of a “battery.” For example, the thermal mass “battery” may have infinite cycles with no degradation of performance over time, 100% electrical efficiency, a 6-9 hour storage duration, and a decent ramp rate (can be fully discharged in 1 hour). The character of this thermal mass battery may be dictated by whether the building is concrete or steel, how much drywall, whether marble floors or rugs, etc. The attributes 401 may be considered diurnal storage derived from thermal mass, short-term storage (e.g. as derived from chilled water loop or ventilation or humidity control), ability to oscillate intra-minute (e.g. as can be done by controlling a variable frequency drive on an air handling unit), short notice response, multi-hour notice response; etc.

Attributes 401 may also include: 1) the ability of an HVAC system to quickly change its operation and so its electric load; 2) thermal inertia (e.g. in thermally massive buildings, tenant comfort can be unaffected by intra-hour variation in HVAC system operation in response to a control signal sent by the electric grid operator); 3) buildings with demand controlled ventilation monitoring and control system can respond to hourly and sub-hourly grid signals; 4) newer buildings with tight building envelopes may store thermal energy more efficiently and for longer periods of time; 5) buildings with VFD's might more efficiently respond to regulation signals because they are efficient over a wider range of part load operation; and 6) different air handling units have steeper/shallower electric load change in response to changes in air flow. In other words, the unbundling of attributes may also include the unbundling of response rate and duration curves associated with individual components or materials and bundles of components and materials.

Attributes 401 may include the use of ramp rate 704. CO₂ control (through DCV) may be used for a quick ramp or simply to move energy out of one pricey hour and into a nearby cheap hour. Cold water may be yet another energy bank, but potentially for a short-term (a couple of hours). CO₂ concentration may be referred to as a battery because CO₂ concentration may be driven down by over-ventilation in a low-priced hour (with resulting low expense) in anticipation of letting it rise to some maximum threshold in an hour when prices are high (with resulting high expense savings).

Cold water 706 may be yet another energy bank, but potentially for a short-term (a couple of hours). The humidity level 708 may similarly be used as a bank. Each of the attributes 401 may be individually controlled within a facility, however, the optimizer 202 identifies and unbundles these attributes from multiple facilities using decision analysis to optimize the overall energy usage and the provision of each attribute for each building.

FIG. 8 is a diagram illustrating exemplary markets 102. The markets 102 that provide resources may include energy 802, capacity 804 and ancillary services 806 as three examples. Energy 802 may include electric and/or gas. In other words, an electric market provides electricity to the facilities and a gas market provides gas to the facilities. In addition, the electric market may include a wide array of wholesale electric grid markets (and their associated products), so that there is an application to suit every facility's attributes and, as part of a synthetic resource, many facilities may choose among competing market opportunities. The electric grids may combine multiple functions and markets to provide you with reliable, low cost electricity. As described, the system is providing functionally equivalent products/services from facilities back to the grid and getting paid the same as a generating plant providing such services. Examples of electric grid markets 806 may include energy, capacity, spinning reserve, regulation, balancing, frequency control, and other electric grid functions. Other examples of internal markets possible within an aggregation may include: 1) self-supply of ancillary services 806 in electric markets; 2) coordinated investment in local distribution system demand reduction; and 3) capacity market 804 for pooled on-site generation. Other examples of markets 102 may include spinning reserve, regulation, balancing, frequency control, and other electric grid functions.

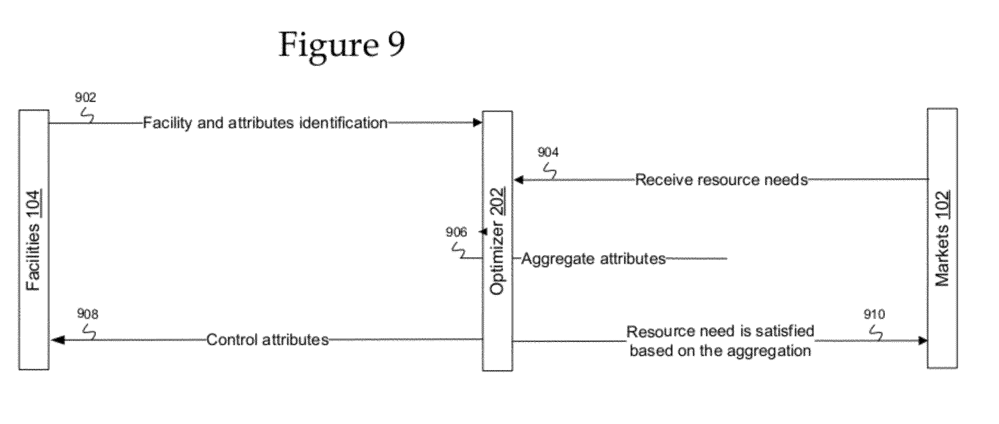

FIG. 9 is a diagram illustrating synthetic resource deployment and communications. The optimizer 202 communicates with the facilities 104 and the markets, 102 for the purpose of optimizing supply and demand between the facilities and markets. In block 902, the facility and attributes are identified by the optimizer 202. The markets 102 provide their resource needs in block 904. In block 906, the optimizer 202 aggregates the attributes to optimize the value of those attributes to meet the resource needs. Decision analysis may be used for the unbundling and/or the aggregation. In block 908, in order to deploy to the markets, the attributes are controlled to meet the resource need. In block 910, the resource need is satisfied based on the aggregation and the control of the facilities. For example, one can control the thermal storage attribute of a portfolio of buildings by sending a temperature set point strategy to the building management systems of each of the buildings.

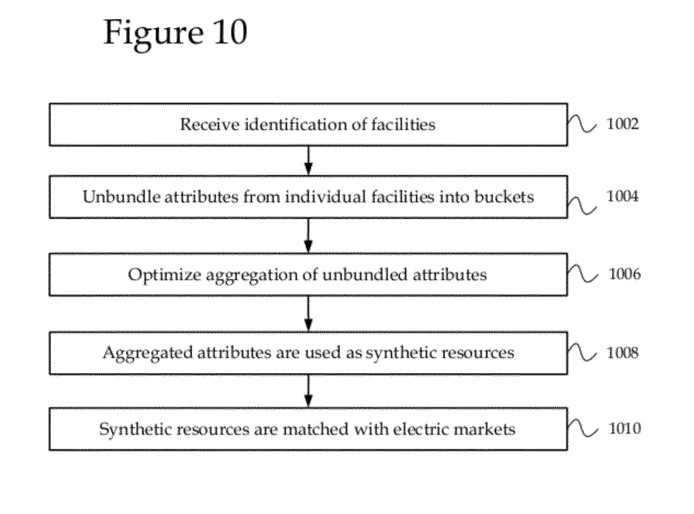

FIG. 10 is a flowchart illustrating optimization. In block 1002, the identification of facilities is received and attributes from those facilities are unbundled in block 1004. The buckets of unbundled attributes are aggregated or rebundled as in block 1006. The rebundling may be performed through decision analysis. The aggregated attributes may be referred to as synthetic resources in block 1008. The synthetic resources may then be matched with electric markets for resource deployment in block 1010.

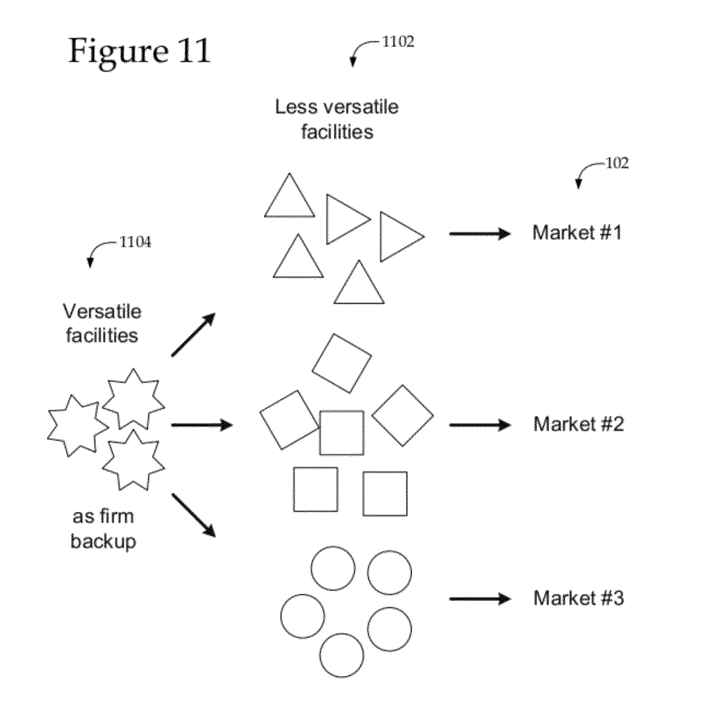

FIG. 11 is a diagram of a system illustrating flexible aggregation. The markets 102 are connected to aggregated facilities 1102 that may be less versatile or flexible in terms of market usage. Accordingly, more versatile facilities 1104 may be used as backup to the less versatile facilities 1102. In other words, the versatile facilities 1104 may be the best buildings that wait for an assignment (unbundling and combination with a less versatile facility) to level off any spikes in demand from the market. In other words, a few C&I facilities with significant capability and flexibility may stand behind several different groups of less flexible facilities, enabling simultaneous and economical participation in several markets requiring firm resources. Firmness may be required in order to participate in some markets (e.g. reliability markets), or firmness may reduce collateral requirements. The versatile C&I facilities may require compensation reflecting their superior contribution.

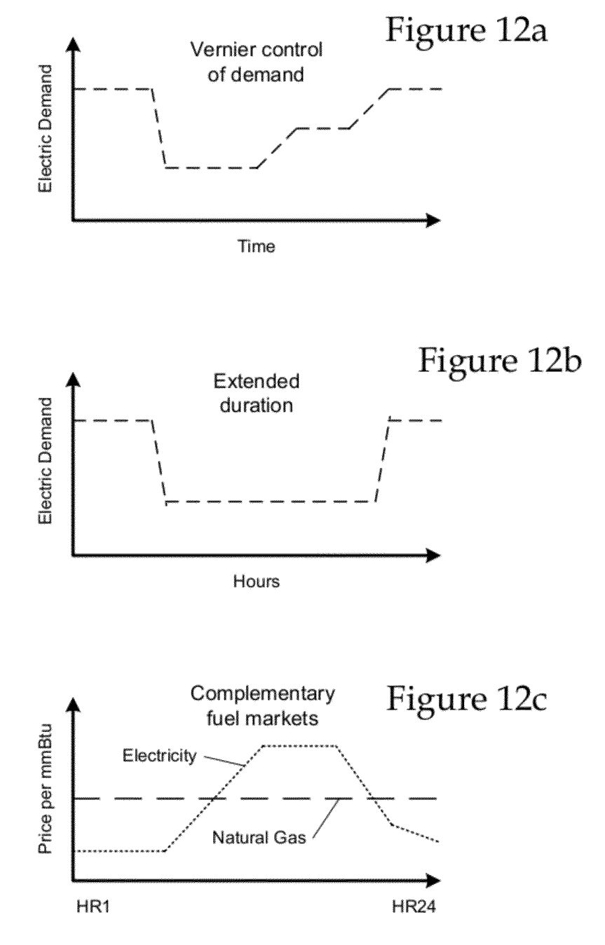

FIGS. 12a-c are graphical representations of demand and price. FIG. 12a illustrates how multiple C&I facilities permit a granularity of control because each facility comprises a small portion of the group and because at least one of several contributing facilities is likely to have fine control (and one such facility may be all that it takes to achieve such granularity for the group). Applications may include spinning reserve and regulation. As with generating plants, multiple facilities may ramp further, faster than can individual facilities.

FIG. 12b illustrates that multiple C&I facilities can commit to stand by or respond for a longer continuous time span, such as in electric capacity markets. Likewise, a fast responding facility may respond first while a less flexible facility, (e.g. a longer term facility) may performs an orderly shutdown.

FIG. 12c illustrates that multiple markets may complement in different respects, e.g., natural gas and electric markets may complement one another. Natural gas may be a choice for space and water heating during the day when natural gas-fired generators are at the margin producing electricity. The higher the natural gas price, the clearer the choice. Conversely, electricity is competitive for heating on nights and weekends when nuclear or coal-fired generators are at the margin producing electricity—the higher the natural gas price, the more economical electricity. Reliability and economy markets may also complement. For example, C&I facilities may not commit to more than one reliability market. However, facilities may commit simultaneously to a reliability market (requiring firm commitment to standby) and an economy market (a voluntary market). In this example, on days that a facility is called on to perform in a reliability market, it may simply withdraw from or curtail future hour participation in an economy market. On other days, the facility may collect standby revenues in reliability markets while capturing opportunities in economy markets.

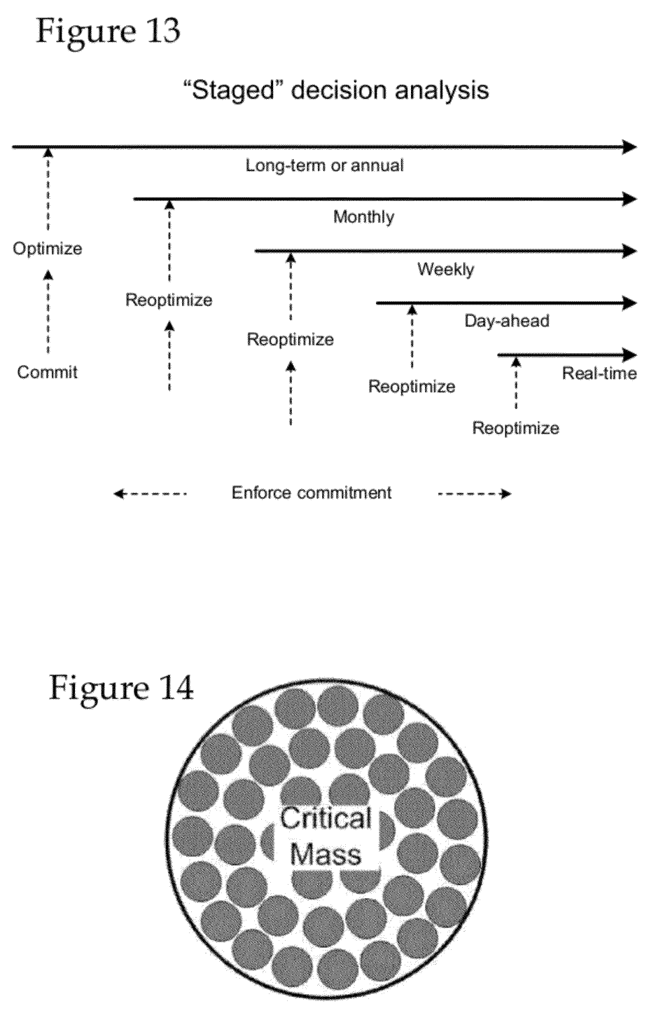

FIG. 13 is a diagram of staged decision analysis. Long-term and short-term markets may complement one another as illustrated in FIG. 13. Optimization and commitment may initially take place across markets with several time dimensions. Reoptimization may continually take place across fewer and fewer time-differentiated markets. Eventually, reoptimization may take place on the real-time market only. The long-term or annual commitments on the left of FIG. 6 may be repeatedly reoptimized. As the time commitments decrease, the reoptimizations take place while considering the longer term commitments. In other words, longer term commitments may affect the optimization based on shorter term commitments.

Decision analysis techniques may both identify complimentary markets and then optimize deployment of a group of facilities in such markets. Because C&I facility capability may not exactly match market opportunity, some remnant of capability may go unused. Partial facility capabilities that would otherwise go unused may be aggregated—by volume or in other complementary ways—into useful resources. As another example, participation in reliability markets may include holding some capability in reserve for reliability events that may or may not occur. Some capability may be unused for each C&I facility. Instead, time-staggered facilities relieve each other of firm commitments, leaving only a portfolio end-effect to deal with.

FIG. 14 is a diagram illustrating critical mass. Concentrated or local aggregation may make achieving critical mass sufficient, for example, to affect transmission-congestion pricing, local distribution system loading, or reactive losses. This may occur in a large metropolitan area with transmission bottlenecks, expensive distribution systems and electric load is concentrated. For example, control of ten buildings in ten different cities may have little effect on the utility distribution systems in those ten different cities, but control of ten buildings in the same city block may result in the local utility requiring far less electric distribution capacity supplying that one block. The transmission capacity needed is reduced. Underground transmission and distribution may exacerbate reactive losses. As a corollary, concentration may improve the ability to maximize price*volume, which assumes that the C&I portfolio does not have market power and is instead relieving generator market power. Power supply contracts and utility tariffs may charge for reliability through a demand charge on non-coincident peak load of a C&1 facility. By contrast, the actual reliability burden may be related to the coincident peak load of a facility. First, by participating in reliability markets, a facility may recapture reliability charges to the extent its non-coincident peak load is not reflective of its coincident peak load. This may be achieved in aggregation. Second, an aggregation of facilities may commit to controlling its coincident peak load for reliability markets and thus is more likely to recapture such reliability charges. The benefit of participating in energy markets may be positively correlated with volatile year-to-year and season-to-season energy market prices and negatively correlated with facility electric bills. The resulting volatility of benefits may be seen by all C&I facilities and valued more by some and less or not at all by others. In a large aggregation of C&I facilities, enough liquidity exists to trade volatility among facilities and between facilities and their energy suppliers.

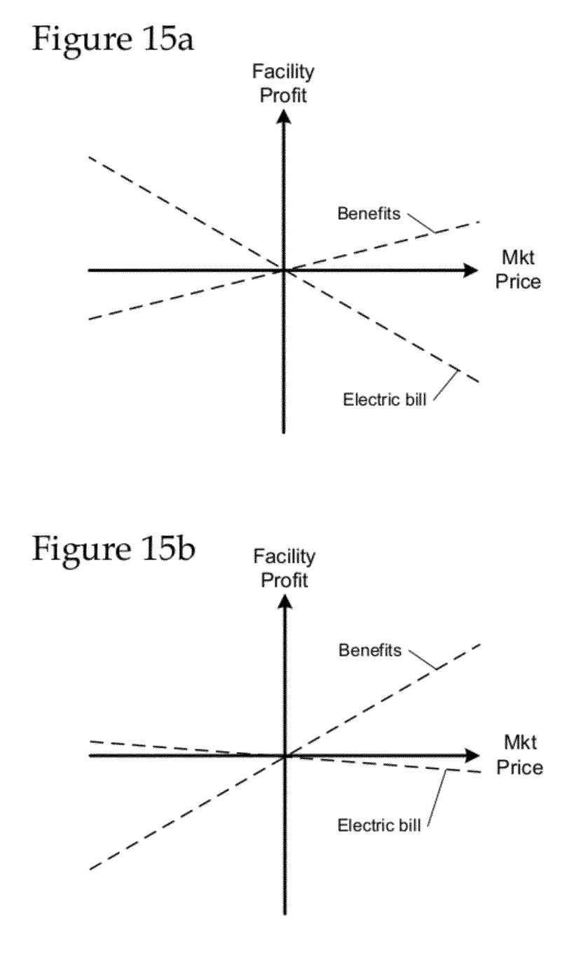

FIGS. 15a-b are graphical representations of financial risk management profiles. In FIG. 15a, volatile benefits may help but not completely offset the effects of electric bill volatility on the bottom line. This facility values and would pay extra for greater volatility of benefit to offset volatile electric bill expenses. FIG. 15a may be typical of a facility taking power subject to a market index or with highly weather-sensitive electric/gas load. Conversely, in FIG. 15b, the facility does not value the volatile benefits and may like to swap the volatile benefits for the equivalent value of fixed benefits. FIG. 15b may be typical of a facility on a fixed, long-term energy price.

The foregoing embodiments and examples describe how decision analysis techniques can create synthetic resources from C&I facilities and optimally deploy those resources in gas and electric markets to create significantly improved value over traditional deployment methods. The wide range of applications indicates the ability to create value for large aggregations of C&I facilities. Diversity of facilities that may be achieved through aggregation enables more opportunity than the traditional mean-variance and scale benefits. Diversity of facilities provides an opportunity to identity and monetize complementary facility attributes and capabilities. Likewise, diversity of energy markets provides an opportunity to identity and monetize complementary energy markets.

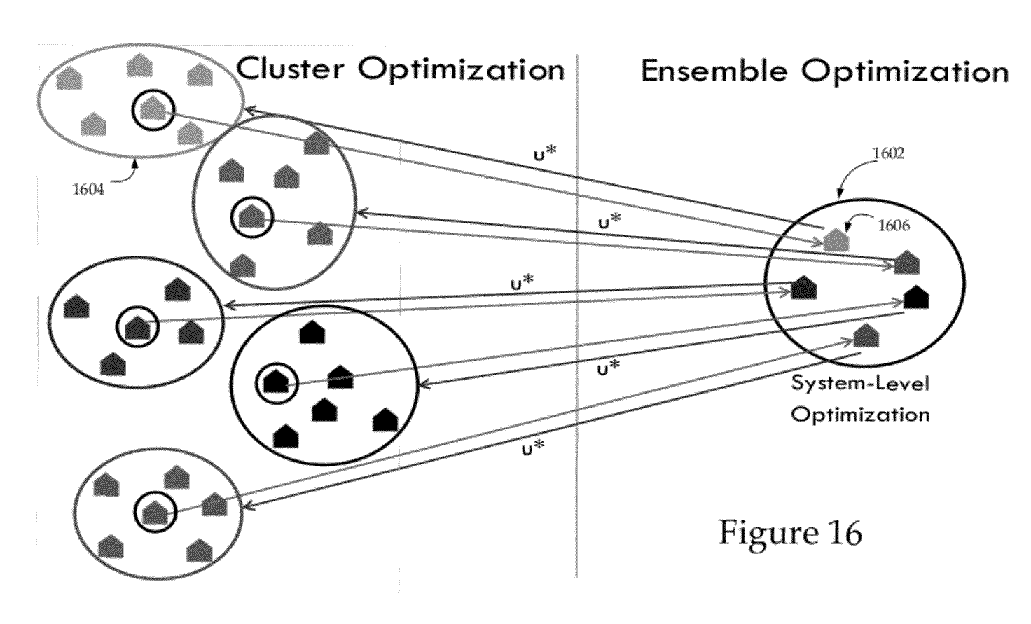

FIG. 16 is a diagram illustrating facility clustering. FIG. 16 illustrates a number of buildings or facilities that are cluster together, such as the cluster 1604. The clustering of facilities or buildings may be through an optimization procedure as discussed above, such as with decision analysis. Based on the clustering a representative facility is selected. For example, for cluster 1604, facility 1606 is representative of each of the facilities in cluster 1604. Representative facility 1606 may be referred to as the advocate, or the advocate building. The clustering or aggregation of facilities may be used for optimizing at a system level by using a portfolio of representative facilities 1602. As discussed below, the clustering or classification of facilities/buildings may result in more efficient monitoring and control of resources to all the facilities.

Advanced building control and fault detection methods may utilize building energy models to predict or estimate expected building performance Online implementation of such methods when considering the advanced control of a large number of buildings in a portfolio, suggests lower complexity, computationally efficient models that capture the critical system dynamics. Inverse grey box models as an approach to reduced order modeling may have potential for blending the benefits of building physics knowledge with measured performance data. Inverse grey box building models may predict cooling loads and energy consumption for optimal control strategy evaluation, as well as online next-day load predictions. Extended Kalman Filters may be incorporated with similar model structures to improve real-time load estimates using available data.

Inverse grey box reduced order models may be based on the approximation of heat transfer mechanisms with an analogous electrical lumped resistance-capacitance network. This approximation may create a flexible structure that allows the selection of an appropriate level of abstraction. Model complexity may range from representing entire systems with a few parameters, to modeling each heat transfer surface with numerous parameters. Depending on the model structure and complexity, model parameters may adequately approximate physical characteristics of the system. Model parameters may then be identified through a training period with measured data in a process known as parameter estimation.

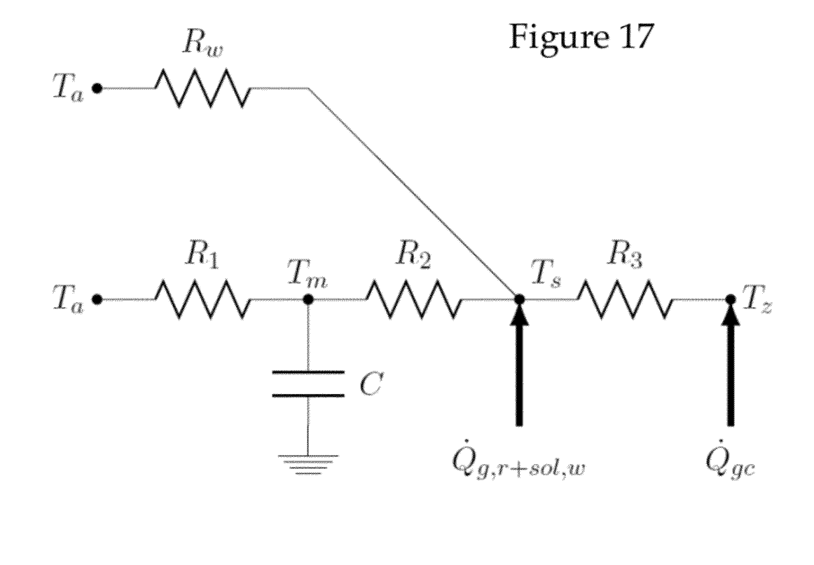

FIG. 17 is a diagram illustrating a thermal network model. FIG. 17 illustrates the reduced order modeling approach with a five-parameter model. The model may be used to predict summer cooling loads for both a small retail and a large office buildings. Heat transfer through the opaque building shell materials may be represented by resistances R1, R2, and capacitance C. These elements link the ambient temperature node to a pseudo surface temperature node (Ts), accounting for potential heat storage of the mass materials. Glazing heat transfer is represented by a single resistance Rw connecting the ambient temperature node to the surface temperature node, as thermal storage of glazing is typically neglected. R3 represents a lumped convection/radiation coefficient between the surface temperature node and zone air temperature node Tz. The convective portion of internal gains (lighting, occupants, and equipment) are applied as a direct heat source to the zone temperature node, shown as Q·gc, and the radiant fraction along with glazing transmitted solar gains (Q·g,r+sol,w) are applied to the surface node. Although, convective and radiative splits are made, radiative heat transfer mechanisms are lumped together in R3.

An energy balance can be carried out on the mass node temperature Tm and the resulting system of equations can be arranged in computationally efficient state space notation. The resultant state space model is converted to a transfer function model. The transfer function method is an efficient calculation method as it relates the sensible heat gains to the space (Q·sh) at time t to n past inputs and m past heat gains previous timesteps, where n and m are adjustable back horizons in hourly increments. Using an inverse form of the transfer function, allows for the determination of predicted building temperature Tz.

The parameters (the R and C values) of such a reduced order model can be found using non-linear least squares minimization techniques that minimize the root-mean-squared error (RMSE) between the reduced order model and the measured building data. A two-stage optimization is implemented that first performs a direct search over the parameter space to identify a starting point for local refinement. The direct search is performed on p uniform random points located within the bounds of the parameter space. The local refinement, subject to the same parameter constraints, is performed via a nonlinear least squares minimization based on trust-region-reflective Newton optimization methods.

With the parameters estimated for each reduced order model of each building under investigation in the portfolio, the buildings are classified or clustered using clustering methods including centroid (e.g., k-means) and distance connectivity (e.g., hierarchical) clustering. The attributes used by the clustering analysis are the parameters of the reduced order models. For illustration, a reduced order model involving five building envelope parameters (R and C values) as well five parameters associated with the heating, ventilating, and air-conditioning systems (HVAC) such as system efficiencies, part-load characteristics and capacities, would have a total of ten parameters and thus be a point in a ten-dimensional attribute space. Since these parameters have physical meaning, relative proximity of buildings in any attribute dimension can be directly interpreted as physical similarity in the particular attribute. Overall, buildings whose reduced order models cluster together tightly may be classified or clustered as being similar buildings.

Upon successful development of the reduced order models for each building and the estimation of the parameters for these reduced order models based on measured building automation data and field audit data, the classification reveals that the clusters shown in FIG. 16, of which cluster 1604 is one of five clusters. Extending this illustration to a larger portfolio of buildings than six, one can illustrate a large number of commercial buildings to naturally classify into a smaller number of clusters. Once the classification has been successfully accomplished for the building portfolio under investigation, a representative building in each cluster, coined the advocate building, is selected. The selected cluster advocate is the building that is most representative of the cluster of buildings. In FIG. 16, the advocate building for cluster 1604 is facility 1606. Each of the five clusters in FIG. 16 would have an advocate building which are shown in the grouping of 1602. The grouping 1602 may be generated from the reduced order models of the advocate buildings. The grouping 1602 may be referred to as an ensemble, and the number of buildings in an ensemble may be small (e.g. 2-5) and may be generally be smaller than the number of buildings in the available portfolio of buildings.

The process of assembling the building ensemble is governed by the desired complementary set of building features and attributes best suited to the optimal control task at hand. For example, medium-weight buildings (in terms of building thermal mass) may be effectively combined with buildings featuring low internal gains from lights and equipment in an effort to respond to sub-hourly electric markets such as five-minute prices. In another example, heavier-weight buildings may be combined with those that feature good part-load performance of the HVAC systems to provide efficient diurnal precooling during unoccupied periods, a process that resides on the time scale of hours or days rather than minutes.

The ensemble of buildings may be optimized as an entity, i.e., all members of the ensemble may be optimized simultaneously in a system-level optimization to allow for tradeoffs and beneficial interactions between ensemble members to emerge and be harnessed. The underlying premise of the ensemble optimization is that, by harnessing complementary building attributes and features, synergistic effects are achieved, i.e., that the results of the ensemble optimization exceeds the sum of the results of separate optimizations for each building advocate. Ensemble optimization may provide synergy, if not necessarily scale.

Given that the advocates may be the most representative building model for each corresponding cluster of buildings, optimal solutions (shown as control vectors u* in FIG. 16) found during the system-level ensemble optimization may be passed back to the original clusters and applied to each building associated with the cluster. In other words, while ensemble optimization achieves synergistic effect by exploiting complementary building features, the subsequent cluster optimization achieves scale by leveraging the optimal solution found for the advocate buildings to the entire cluster. When all clusters are optimized this way, both synergy and scale may be achieved in the entire building portfolio.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A computerized method comprising:
identifying facilities for energy optimization;
unbundling components from each of the identified facilities;
optimizing the unbundled components by rebundling components into optimal aggregations; and
deploying the rebundled components.

2. The method of claim 1 wherein the optimizing comprises receiving resources from markets, wherein the deploying comprises receiving resources from the markets based on the rebundled components.

3. The method of claim 2 wherein the markets comprise gas and electricity delivery.

4. The method of claim 3 wherein the resources comprise energy delivery.

5. The method of claim 1 wherein the unbundling and optimizing utilizes decision analysis for optimizing the deploying of the rebundled components.

6. The method of claim 1 wherein the optimizing comprises selecting which of the markets deploy certain of the resources and further selecting when those resources are deployed.

7. The method of claim 1 wherein the attributes comprise at least one of a thermostat value, air ventilation, or humidity level.

8. A non-transitory computer readable medium having stored therein data representing instructions executable by a programmed processor for optimizing energy usage, the storage medium comprising instructions operative for:
accessing one or more facilities that receive resources from one or more markets;
identifying attributes from the facilities;
aggregating the identified attributes for optimal usage of the resources; and
deploying the resources from the markets based on the aggregation of the attributes.

9. The computer readable medium of claim 8 wherein the attributes comprise at least one of a thermostat value, air ventilation, or humidity level.

10. The computer readable medium of claim 8 wherein the identifying and aggregating utilizes decision analysis for optimizing the deploying of the resources.

11. The computer readable medium of claim 8 wherein the markets comprise gas and electricity delivery.

12. The computer readable medium of claim 11 wherein the resources comprise energy delivery.

13. The computer readable medium of claim 8 wherein the optimal usage of the resources comprises selecting which of the markets deploy certain of the resources and further selecting when those resources are deployed.

14. The computer readable medium of claim 8 wherein the identifying and aggregating are iteratively repeated for optimizing the aggregation of the attributes.

15. A system for optimizing facility energy usage comprising:
an optimizer that receives attributes from a plurality of facilities and receives information about resources provided by a plurality of markets, the optimizer comprising:
an unbundler that identifies the attributes from each of the facilities;
an aggregator coupled with the unbundler that combines the attributes from the facilities into an optimal aggregation; and
a deployer coupled with the aggregator that utilizes the optimal aggregation for deployment of the resources from the markets.

16. The system of claim 15 wherein the deployer controls receipt and delivery of the resources based on the aggregated attributes.

17. The system of claim 15 wherein the markets comprise gas and electricity delivery.

18. The system of claim 17 wherein the resources comprise energy delivery.

19. The system of claim 15 wherein the at least one of the unbundler, aggregator, or deployer utilizes decision analysis for optimizing the aggregation of attributes and the deployment of resources based on that aggregation.

20. The system of claim 15 wherein the attributes comprise at least one of a thermostat value, air ventilation, or humidity level.
